(19) United States
(12) Patent Application Publication
(10) Pub. No.: US 2003/0204958 A1
(43) Pub. Date: Nov. 6, 2003

(54) Razor extension assembly

(76) Inventor: Katherine Jewell, Miami, FL (US)

Correspondence Address: David P. Lhota, Stearns Weaver Miller, Suite 1900, 200 East Broward Boulevard, Fort Lauderdale, FL, 33301, US

(21) Appl. No.: 10/428,491

(22) Filed: May 3, 2003

Related U.S. Application Data
(60) Provisional application No. 60/377,633, filed on May 3, 2002.

(51) Int. Cl. B26B 21/00; B26B 21/24; B26B 21/44; B26B 21/52; B26B 21/40; B26B 21/50

(52) U.S. Cl. 30/537; 30/536; 30/538

(57) ABSTRACT

A razor extension handle having a lightweight, collapsible, telescopic extension rod that can be attached or is attachable to a disposable safety razor at one end for shaving body hair and a sponge at an opposite end for applying shaving cream, lotion or soap. The razor extension handle extends outward in a manner that facilitates shaving remote portions of the body when obesity or injury prevents adequate limberness to use a conventional disposable razor.

### CROSS REFERENCE TO RELATED APPLICATIONS

This application claims the benefit of provisional application Serial No. 60/377,633 filed May 3, 2002.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to razors, and more particularly, to a razor extension assembly for extending the reach of a razor.

2. Description of the Background Art

Conventional razors fit in the hand and are not designed for reaching difficult or distal regions of the body. For instance, one must bend over and be reasonably limber to shave their legs. Shaving legs can be especially difficult or impossible for the obese or physically challenged. There are no known devices that provide an adequate extension for razors. Accordingly, there exist a need for such a device. The instant invention addresses this unfulfilled need in the prior art.

### BRIEF SUMMARY OF THE INVENTION

In light of the foregoing, it is an object of the present invention to provide a device for holding and, or attaching a razor and extending it to remote, hard to reach areas.

It is another object of the instant invention to provide a collapsible, extension handle for holding and extending a razor.

It is also an object of the instant invention to provide a collapsible, extension handle for holding a razor and having a sponge or pad for receiving and applying soap, lotion or other desired solutions.

It is an additional object of the instant invention to provide a collapsible, extension handle for holding and extending a razor in a manner that permits the user to shave remote portions of the body that are difficult to reach because of physical limitations.

In light of these and other objects, the instant invention comprises a collapsible, extendable handle for a razor typically used in shaving bodily hair. The razor extension handle may include a preattached or premounted razor or may be adapted for attaching or mounting an existing razor. A sponge or pad may also be included with the collapsible, extendable handle for holding and applying soap, lotion or other solutions. In the preferred embodiment, the razor extension of the instant invention provides a lightweight collapsible extension handle that can be attached or is attachable to a disposable safety razor at one end for shaving body hair and a sponge at an opposite end for applying shaving cream, lotion or soap. The invention primarily facilitates shaving remote portions of the body when obesity or injury prevents adequate limberness to use a conventional disposable razor. The razor extension is collapsible for convenient storage.

### BRIEF DESCRIPTION OF THE SEVERAL VIEWS OF THE DRAWINGS

FIG. 1 is a pictorial view of the preferred embodiment of the razor extension handle of the instant invention as preferably used.

FIG. 2 shows a perspective view of the preferred embodiment of the razor extension handle of the instant invention.

### DETAILED DESCRIPTION OF THE INVENTION

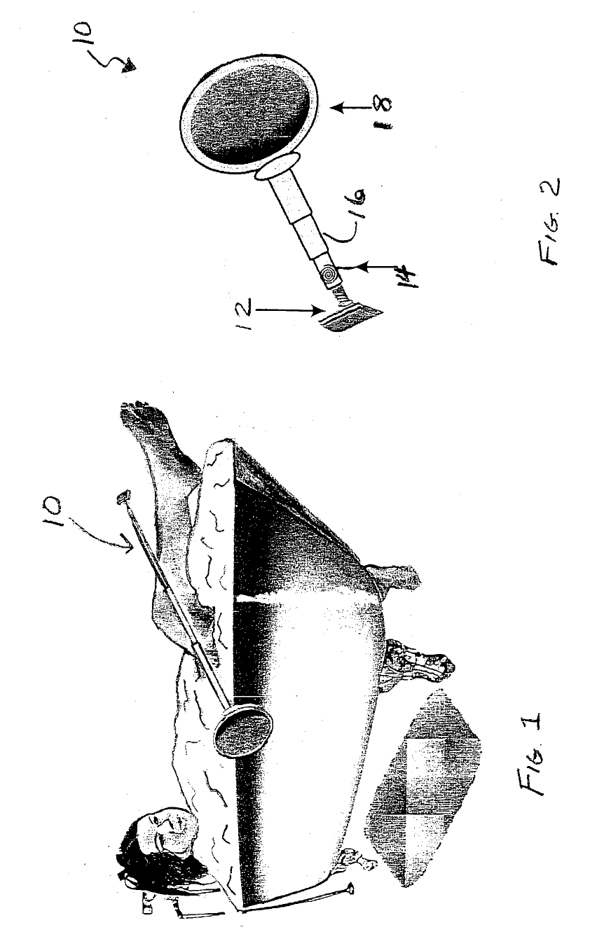

With reference to the drawings, FIGS. 1 and 2 depict the preferred embodiment of the instant invention which is generally referenced as a razor extension handle and, or by numeric character 10. Referring to FIG. 1, the razor extension handle 10 is extendable for shaving and, or cleaning difficult to reach areas while bathing or showering.

With reference to FIG. 2, the razor extension handle 10 comprises a razor or razor attachment 12, sponge 18, collapsible handle 16, and adaptor or wedge 14 for securing the razor 12 to the handle 16. The razor attachment 12 is connected or connectable at one end, i.e. the distal end, to the extension handle 16 by the adaptor/wedge 14. The adaptor 14 may comprise an interlocking mated device, fasteners, threaded pieces and, or other conventional fastening adaptors. The sponge 18 is connected or connectable to the handle 16 at an opposite or proximal end. The sponge or pad 18 is attached or mounted to a base or platform, such as with adhesives or fasteners. The handle 16 of the razor extension 10 is preferably lightweight, collapsible and extendable. The handle 16 may be partially extended or fully extended. The handle 16 comprises a plurality of telescoping rods that allow the handle to collapse and extend. Each telescoping rod 16 has a different diameter and a stop to prevent the rods from becoming completely separated. The handle 16 is also adapted for attaching a disposable safety razor 12 for shaving body hair. The opposite or proximal end of the collapsible handle 16 may be fitted with or have an interchangeable and attachable sponge 18 for applying shaving cream, lotion or soap to the body. The razor extension 10 is rotated approximately 180° to use the sponge/pad 18 and the handle 16 may be extended to apply the lotion, soap or solution.

The razor extension 10 may be made from colored or colorless, opaque or transparent plastic square tubing or lightweight aluminum square tubing. The device 10 may be fitted with a replaceable sponge 18 or lotion dispensing pad 18 for increased utility. The disposable safety razor 12 or razor extension 10 may be fitted with a swivel head to minimize nicks and cuts when the device is used or extended to near maximum length.

The lightweight, collapsible handle 16 is preferably made from molded polyethylene, polyvinyl chloride (PVC), nylon plastic or aluminum tubing. The cross section of the handle 16 may be square, rectangular, circular or oval and preferably includes sections of progressively smaller concentrically disposed cross sections. These smaller sections fit within the successively larger sections to produce a telescoping handle 16.

The razor extension 10 permits obese people or people with back injuries or other physical limitations to shave their legs and other remote parts of the body without having to reach or bend. By providing an extendable handle 16, the invention 10 facilitates greater comfort while shaving. At the same time, the invention 10 facilitates the washing of difficult to reach sections of the body.

The razor extension 10 comprises a lightweight collapsible handle 16 that can be temporarily attached to a disposable safety razor 12. The free end of the collapsible handle 16 can be attached to a replaceable sponge 18 or lotion-dispensing pad for applying shaving cream, lotion or soap. The invention 10 may be made from plastic or lightweight aluminum tubing. The disposable safety razor may comprise a swivel head to minimize nicks and cuts. The handle of the disposable safety razor 12 may be temporarily secured into the handle by the wedge, clip or pin 14. The handle 16 may be made in fashion colors for identification and increased consumer appeal. The extension razor 10 is used in the same manner as a conventional disposable razor except that the extended reach allows shaving in remote areas that were previously inaccessible.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. An extendable and collapsible handle for razors used in shaving body hair, said razor handle comprising:
an extendable and collapsible rod, said rod comprising a distal end and a proximal end;
means for removably mounting a razor; and
means for applying soap or lotion to the body prior to shaving.

2. A razor handle as recited in claim 1, wherein said extendable and collapsible rod comprises:
a plurality of telescoping rods wherein in at least one rod is at least partially and slidably disposed in another rod.

3. A razor extension handle as recited in claim 2, wherein said plurality of telescoping rods comprises at least three rods concentrically and slidably engaged.

4. A razor extension handle as recited in claim 2, wherein said plurality of telescoping rods comprises stops for preventing said rods from becoming completely separated.

5. A razor extension handle as recited in claim 1, further comprising a replaceable razor removably attached to said distal end.

6. A razor extension handle as recited in claim 1, wherein said means for removably mounting a razor comprises:
an adaptor.

7. A razor extension handle as recited in claim 1, wherein said means for removably mounting a razor comprises:
a wedge adaptor.

8. A razor extension handle as recited in claim 1, wherein said means for removably mounting a razor comprises:
threaded adaptors.

9. A razor extension handle as recited in claim 1, wherein said means for removably mounting a razor comprises:
an interlocking snap-fit adaptor.

10. A razor extension handle as recited in claim 1, wherein said means for removably mounting a razor comprises:
hardware fasteners.

11. A razor extension handle as recited in claim 1, wherein said means for applying soap or lotions comprises:
a sponge attached to the handle.

12. A razor extension handle as recited in claim 1, wherein said means for applying soap or lotions comprises:
a pad attached to the handle.

13. A razor extension handle as recited in claim 1, wherein said means for applying soap or lotions comprises:
a sponge removably attachable to the handle proximal the proximal end.

14. A razor extension handle as recited in claim 1, wherein said means for applying soap or lotions comprises:
a pad removably attachable to the handle proximal the proximal end.

15. A razor extension handle as recited in claim 1, wherein said means for applying soap or lotions comprises:
a base proximal the proximal end adapted for removably mounting a sponge or pad.
